(19) United States
(12) Patent Application Publication
(10) Pub. No.: US 2004/0029543 A1
(43) Pub. Date: Feb. 12, 2004

(54) Flexible frequency-hopped spread spectrum suppression scheme

(76) Inventors: Greg Steele, Fremont, CA (US); Eric Fain, Sunnyvale, CA (US)

Correspondence Address: Keith D. Nelson, Lockheed Martin Corporation, Building 220, Mail Stop A08, P.O. Box 49041, San Josse, CA, 95161-9041, US

(21) Appl. No.: 10/215,165

(22) Filed: Aug. 8, 2002

(51) Int. Cl. H04B 1/00; H04B 17/02

(52) U.S. Cl. 455/137; 455/131

(57) ABSTRACT

A system and method that rejects interference in a direct-sequence spread spectrum communications system. The system and method implement smooth transitions from hop to hop with minimal transient degradation. Adaptive interference suppression is achieved using a suppression filter and an adaptive algorithm that processes the output of the suppression filter and an estimate of the hopping frequency of the interfering signals to switch between interference filter coefficients of the suppression filter. This creates a notch at the carrier frequency of the interfering signals and rejects interference contained in the communication signals. The interference rejection filter hops with the frequency-hopped spread spectrum interfering signals to maintain its interference rejection capability.

### BACKGROUND

The present invention relates generally to direct-sequence spread spectrum communications systems, and more particularly, to a system and method that mitigates frequency-hopped spread spectrum (FHSS) interference in a wideband communications receiver.

Frequency-hopped spread-spectrum (FHSS) RF communications systems can interfere with other RF communications systems using the same frequency bands. Interference mitigation schemes have the potential to allow other RF communications systems to coexist with a FHSS system.

For example, consider a situation in which the system of interest has an occupied bandwidth that is much wider than the modulated bandwidth of the FHSS interferer. The occupied bandwidth is a result of either direct-sequence (DS) spreading or wide-band single carrier operation. A brute force approach to FHSS interference mitigation would be to implement a bank of phase-locked loops (PLLs), each centered at a hopping frequency of FHSS system. When a FHSS signal hopped into one of these frequency bands the PLL would lock onto the signal and the output of the PLL would be subtracted from the received signal.

Prediction methods have been proposed for narrowband interference mitigation schemes for direct-sequence spread spectrum communications systems. They consist of an interference rejection filter preceding a despreader in a direct-sequence spread spectrum receiver. The optimal filter coefficients for the interference rejection filter depend on the frequency offset of interferer carrier to the direct-sequence spread spectrum carrier.

More particularly, adaptive notched filters for narrow-band interference suppression have been proposed for direct-sequence spread spectrum communications systems using prediction/interpolation filters. When applied to frequency hopped spread spectrum interferers, the techniques must re-adapt at each hop. During the transient period of the adaptive algorithms, the system performance will be degraded. This degradation will occur at each hop. It would be desirable to have an interference rejection scheme that allows for smooth transitions from hop to hop with minimal transient degradation.

Specific known prior art relating to the present invention is a paper by Jiangzhou Wang entitled “On the Use of a Suppression Filter for CDMA Overlay” published in IEEE Transactions on Vehicular Technology, Volume 48, No. 2, March 1999, pages 405-414. The Wang paper is discloses a direct-sequence code-division multiple-access (DS-CDMA) system operating over a Rayleigh fading and sharing common spectrum with a narrowband waveform. A suppression filter at a receiver is employed to reduce the narrow-band interference. The average up-link bit error rate (BER) performance is evaluated. How the performance is influenced by various parameters, such as the number of taps of the suppression filter, the number of multiple-access users, the ratio of narrow-band interference bandwidth to the spread-spectrum bandwidth, the interference power to signal power ratio, and the ratio of the offset of the interference carrier frequency from the spread-spectrum carrier frequency to the half spread-spectrum signal bandwidth are discussed. However, the Wang paper does not address frequency-hopped spread spectrum interferers.

It is an objective of the present invention to provide for an improved system and method that mitigates frequency-hopped spread spectrum (FHSS) interference in a wideband communications receiver. It is a further objective of the present invention to provide for an improved interference rejection system and method for use in a direct-sequence spread spectrum communications system that allows for smooth transitions from hop to hop with minimal transient degradation.

### SUMMARY OF THE INVENTION

To accomplish the above and other objectives, the present invention provides for an improved system and method that mitigates frequency-hopped spread spectrum (FHSS) interference in a wideband communications receiver. The present invention uses a bank of phase-locked loops (PLLs) to acquire and subtract the FHSS interferer. The number of phase-locked loops that are required is flexible and allows for numerous implementation/performance trade-offs.

The present invention cancels frequency-hopped spread spectrum (FHSS) interference. The novel implementation provided by the present invention reduces the number of phase-locked loops that are required. In addition, a novel lock detection scheme makes use of existing functionality with little additional overhead.

The present invention provides for a scheme in which fewer phase-locked loops are required to cover all of the frequency bands. At one extreme, one narrow bandwidth phase-locked loop is used to cancel interference across the entire receive bandwidth. At the other extreme is the brute force approach of using a phase-locked loop for each hopping channel.

There is a performance penalty with associating one phase-locked loop with multiple hopping channels. The approach implemented by the present invention allows a system designer to trade-off performance and complexity. In addition, the present approach is flexible in which frequency bands are assigned to each phase-locked loop. This flexibility can be exploited for use in certain frequency-hopped spread spectrum systems.

The present invention allows for smooth transitions from hop to hop with minimal transient degradation. The present invention generalizes a narrowband interference rejection scheme to provide for an improved frequency-hopped spread spectrum interference rejection scheme.

One embodiment of the present invention is a direct-sequence spread-spectrum communications system that comprises an antenna that receives direct-sequence spread spectrum communication signals containing transmitted data along with interfering signals. The antenna is coupled by way of a bandpass filter to a suppression filter, or notch filter. The suppression filter is coupled by way of a despreader to a demodulator. The despreader and demodulator despread and demodulate the communication signals to produce the originally transmitted signals.

The output of the suppression filter is supplied to an adaptive algorithm that also receives an estimate of the hopping frequency of the interfering signals as an input. The output of the adaptive algorithm is input to the suppression filter to reject interference contained in the communication signals.

During a frequency hop, the algorithm uses approximate knowledge of the current and future frequency-hopped spread spectrum carrier frequency to hop the notch filter along with the interfering signals. A smooth transition is made from one notch filter to the next to minimize transient degradation. The adaptive nature of the algorithm compensates for the imperfect knowledge of the frequency of the interfering signals.

The algorithm adapts to create a notch at the carrier frequency of the interfering signals. When the interfering signal hops, an estimate of the new frequency is supplied to the algorithm. The algorithm uses the information to construct a new notch filter using the previous notch filter and new carrier frequency. The algorithm transitions the suppression filter from the old notch to the new notch. After the transition, the adaptive algorithm adjusts the notch filter to compensate for any error in the frequency estimate of the interfering signals.

An exemplary method comprises the following steps. Data is processed to generate direct-sequence spread-spectrum communication signals. The direct-sequence spread-spectrum communication signals are transmitted. The direct-sequence spread spectrum communication signals are received along with frequency-hopping interfering signals. The received communication signals and interfering signals are bandpass filtered.

The bandpass filtered communication signals and interfering signals are adaptively filtered. The adaptive filtering is achieved using a suppression filter and an adaptive algorithm that processes the output of the suppression filter to hop the suppression filter along with the interfering signals. The adaptively filtered signals are despread. The despread signals are demodulated to produce the original data.

### BRIEF DESCRIPTION OF THE DRAWINGS

The various features and advantages of the present invention may be more readily understood with reference to the following detailed description taken in conjunction with the accompanying drawing, wherein like reference numerals designate like structural elements, and in which:

FIG. 1 illustrates an exemplary interference suppression system in accordance with the principles of the present invention that implements a frequency-hopped spread spectrum interference cancellation scheme;

FIG. 2 illustrates details of a phase-locked loopphase-locked loop (PLL) subunit employed in the system shown in FIG. 1;

FIG. 3 is a simulation flow diagram that was used to simulate the interference suppression scheme implemented by the present invention;

FIG. 4 are graphs that illustrate signals output by the system for differing numbers of phase-locked loopphase-locked loop (PLL) subunits; and

FIG. 5 is a flow chart that illustrates an exemplary interference cancellation method in accordance with the principles of the present invention.

### DETAILED DESCRIPTION

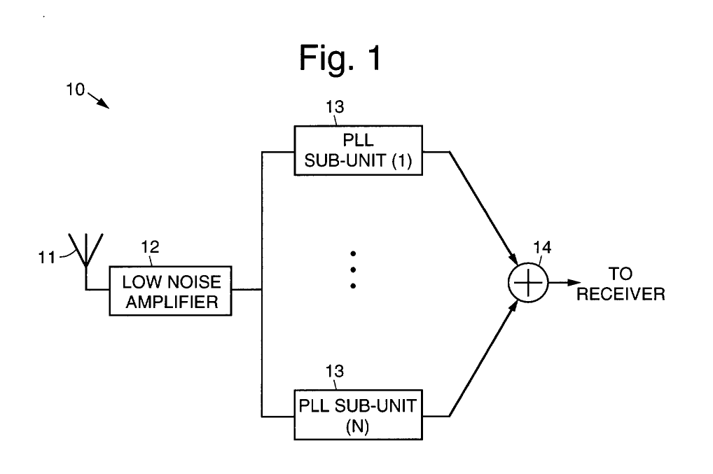

Referring to the drawing figures, FIG. 1 illustrates an exemplary interference suppression system 10 in accordance with the principles of the present invention that rejects interference in a direct-sequence spread spectrum communications system. FIG. 1 is a high level block diagram of the of the interference rejection scheme implemented in the system 10.

The system 10 comprises an antenna 11 that receives a direct-sequence spread-spectrum communication signal along with interfering signals (interferer). The signal received at the antenna 11 is input to a low noise amplifier 12 and is distributed to a bank of phase-locked loop (PLL) subunits 13. Outputs of the phase-locked loop (PLL) subunits 13 are input to a summing device 14 which provides a summed signal to a receiver of the direct-sequence spread spectrum communications system. The architecture of the interference suppression system 10 rejects interference in the direct-sequence spread spectrum communications system.

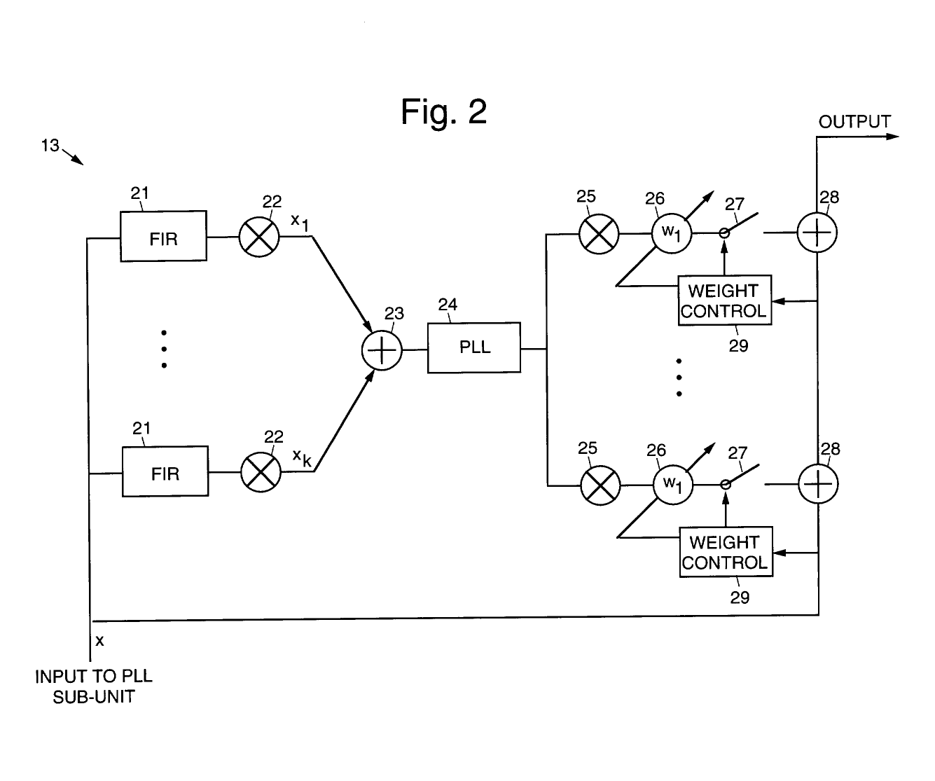

A detailed block diagram of an exemplary phase-locked loop (PLL) sub-unit 13 is shown in FIG. 2. Each sub-unit 13 includes a plurality of bandpass filters 21 (finite impulse response (FIR) filters 21) that are coupled by way of a plurality of down-converters 22 to a summing device 23. The output of the summing device 23 is coupled to a phase-locked loop 24. The output of the phase-locked loop 24 is distributed and processed by a plurality of up-converters 25, whose respective outputs are weighted by a complex weighting circuit 26 controlled by a weight control circuit 29. The output of the respective complex weighting circuit 26 is coupled through a switch 27 and is input to an output summing device 28.

Each bandpass filter 21 is centered at one of the expected hopping frequencies. The down-converters 22 are tuned to take the center frequency of each bandpass filter 21 to DC. The summing device 23 adds each of the baseband signal components for the sub-unit 13. The phase-locked loop 24 tracks any tones that may appear at the input of the sub-unit 13. The output of the phase-locked loop 24 is up-converted to each hopping frequency. The weights are determined to minimize

$$E \{ \vert x + {w}_{k}^{*} {y}_{k} {\vert}^{2} \} . \qquad ( 1 )$$

This is equivalent to choosing the weights

$${w}_{k} = - \frac{E \{ {y}_{k} {x}^{*} \}}{E \{ {y}_{k} {y}_{k}^{*} \}} . \qquad ( 2 )$$

It should be noted that the magnitude of the weight is related to the correlation between yₖ and x. The magnitude of the weight is compared to a threshold and the result is used to control the switch 27. The weighted signal is subtracted from the input signal.

An example of how the system 10 operates is as follows. Assume that a direct-sequence spread spectrum signal (x) appears at the input to a PLL sub-unit 13. With no loss in generality, assume that a frequency-hopped spread-spectrum interfering signal appears at frequency 1. Thus, x, will contain the interfering signal, the desired signal, and noise. The other channels will contain only the desired signal and noise.

Each of the channels is downconverted, summed and sent to the phase-locked loopphase-locked loop 24. In the phase-locked loopphase-locked loop 24, the signal of interest and the thermal noise all appear as noise. The phase-locked loopphase-locked loop 24 locks onto the frequency hopped spread spectrum interfering signal and any noise within the loop bandwidth. The output of the phase-locked loopphase-locked loop 24 is up-converted onto each of the possible hopping frequencies of the frequency hopped spread spectrum interfering signal.

The correlation between the output of the phase-locked loopphase-locked loop 24 on frequency I and the input signal is significant. Thus, a threshold condition will be met and this signal is subtracted from the input signal. On the rest of the hopping frequencies, the correlation is weak. The threshold condition will not be met, and these signals will not be subtracted from the input signal. In this manner, only the correct copy of the frequency hopped spread spectrum interfering signal is removed from the input signal.

From the previous description, the following observations can be made. The interference suppression scheme may be implemented in such a manner that each phase-locked loop 24 receives input from only one hopping channel. This would require as many phase-locked loops 24 as hopping channels. We could implement the scheme so that one PLL receives input from all of the hopping channels. The scheme may be implemented in such a manner that an arbitrary number phase-locked loops 24 (greater than the number of hopping channels) are used, with each phase-locked loop 24 receiving an input from a different subset of the hopping channels.

There are performance penalties related to assigning multiple hopping channels to a phase-locked loop 24. When multiple hopping channels are assigned to a single phase-locked loop 24, the signal of interest and thermal noise act as additional noise on the channel which contains the interfering signal. This can make the acquisition and tracking of the signal more difficult. There may be a situation in which there are multiple frequency hopped spread spectrum interfering signals. If two interferer channels are assigned to the same phase-locked loop 24, the phase-locked loop 24 will track the sum of the interference, but the weighting operation at the output of the phase-locked loop 24 will be unable to assign the interferers to the correct channels for subtraction from the input signal.

Simulations were developed to evaluate the efficacy of the present interference mitigation scheme. A situation was considered in which the signal of interest was a direct sequence spread spectrum signal occupying the same band as the frequency hopped spread spectrum interfering signal. The signal parameters for the frequency hopped spread spectrum interfering signal and signal of interest are given in Tables 1 and 2 respectively.

TABLE 1
Interferer simulation parameters

| Modulation | | binary GFSK |
|---|---|---|
| Data rate | 1 | Mbps |
| Hopping rate | 8000 | hops/sec |
| Frequency separation | 1 | MHz |

TABLE 2
Signal of Interest Simulation Parameters

| Modulation | | BPSK |
|---|---|---|
| Data Rate | 1 | Mbps |
| Spreading sequence | 11 | chip Barker |
| Spreading factor | 11 | chips/symbol |

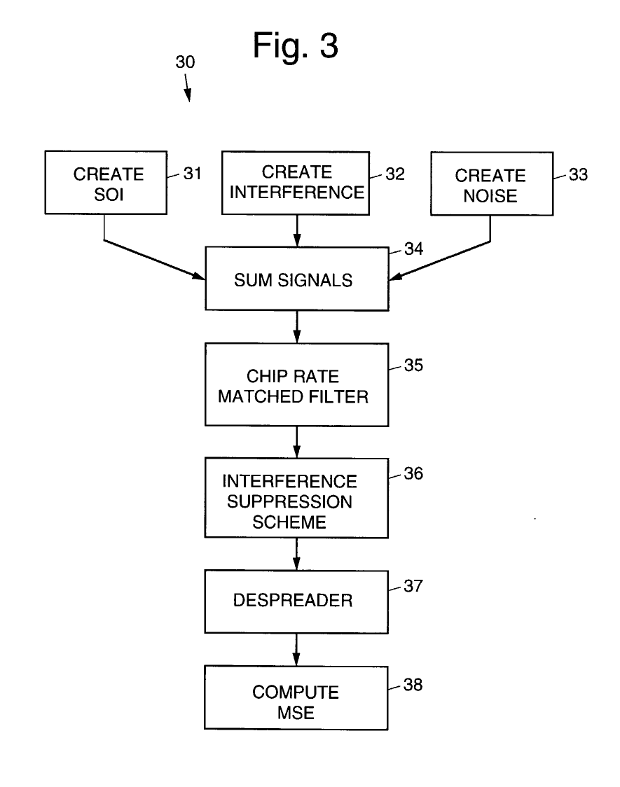

A flow diagram of the simulation 30 is displayed in FIG. 3. A signal of interest (SOI) was created 31. An interference signal (interferer) was created 32. A noise signal was created 33. The signal to interferer ratio (SIR) was −10 dB. The hopping frequency for the interferer followed a sequence beginning at the carrier frequency of the direct-sequence signal continuing out to the chip rate. Since the interference scheme operates at the chip rate, the higher frequencies alias back into the 11 MHz chip bandwidth. The signal of interest, interference signal, and noise were summed 34. The aliased components were attenuated due to a chip rate matched filter 35 preceding the present interference mitigation circuitry 36. The output of the interference mitigation circuitry 36 was despread by a despreader 37.

The mean square error (MSE) of the output signal from the despreader 37 was computed 38, following the despreader 37, for different numbers of phase-locked loops 24 used in the interference suppression system 10. The results are shown in Table 3.

TABLE 3
Simulation results

| Simulation | | Mean Square Error |
|---|---|---|
| No Interference Mitigation | | 0.2 |
| 1 | PLL | 0.042 |
| 2 | PLLs | 0.03 |
| 4 | PLLs | 0.026 |
| 8 | PLLs | 0.025 |
| 11 | PLLs | 0.024 |

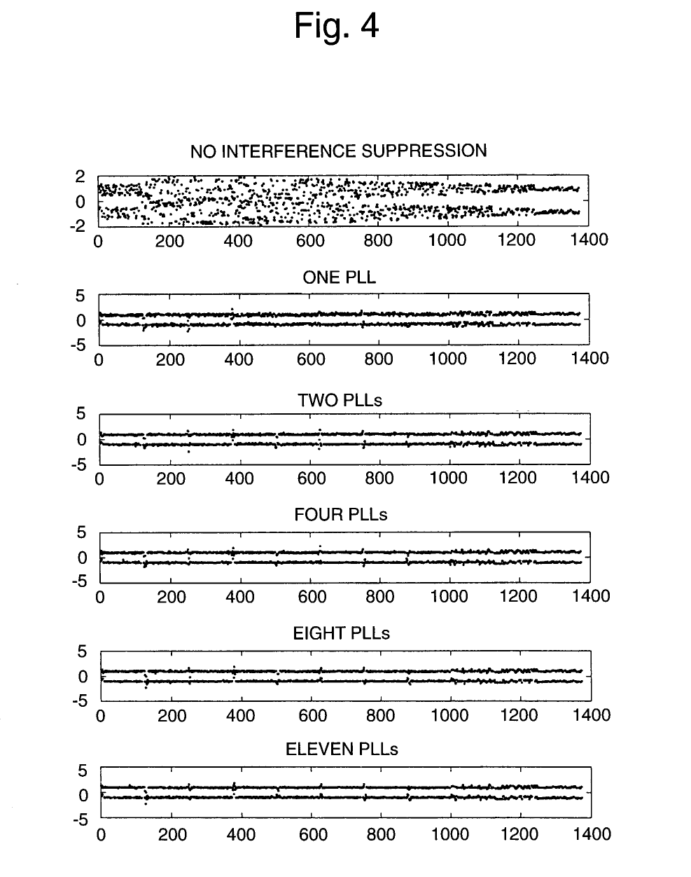

The results demonstrate that the interference scheme with one phase-locked loop 24 provides significant improvement over not using any interference mitigation. The MSE drops by about one half as the number of phase-locked loops 24 is increased to eleven. It may seem surprising that the improvement is not greater as the number of phase-locked loops 24 is increased. FIG. 4 displays the time progression of the SOI constellation for each simulation. For the simulations with interference suppression, the significant deviations from the symbol values occur when the interferer hops. This appears to be the event that is dominating the MSE results. Based upon this observation, one would expect a larger difference in performance between the various simulations if the interferer hopped at a slower rate. In addition, parameters within the interference suppression scheme may be optimized to reduce the errors at the hop time.

Examples of implementations of the present invention will now be discussed. For example, a first approach allows a system designer to trade-off complexity with performance. Consider a situation in which the receiver is implemented on a field programmable gate array (FPGA) or digital signal processor (DSP). One may not be able to fit the a full set of phase-locked loops 24 on the FPGA or a full set of phase-locked loops 24 may not execute in parallel fast enough on the DSP for a given application. The reduction in the number of phase-locked loops 24 may allow implementation on these platforms. Thus, the approach implemented by the present invention allows frequency hopped spread spectrum suppression schemes to be implemented on a broader selection of platforms.

Above, it was indicated that the approach might fail if multiple FHSS interferers were assigned to the same phase-locked loop 24. In some situations, the system designer may have a priori knowledge that the multiple interferers would occur in nonintersecting subsets of the frequency channels. For example, the 802.11 FH standard prescribes three hopping sets. This allows multiple 802.11 frequency hopped (FH) networks to be installed in geographically overlapping areas. A system designer that wishes to suppress interference from an 802.11 frequency hopped (FH) system could prescribe the frequencies from each hopping set to a separate phase-locked loop 24. Even if the system 10 receives interference from the three overlapping 802.11 FH systems, each phase-locked loop 24 will see at most one 802.11 frequency hopped (FH) interferer. The performance of the system 10 will not degrade due to multiple interferers.

Another alternative approach to this problem would be to use a phase-locked loop 24 with a loop bandwidth that spans all possible hopping frequencies. This approach allows a significant mount of noise to enter the phase-locked loop 24. It is believed that it would have similar noise performance as the flexible approach using one phase-locked loop 24. It would suffer from the inability to mitigate multiple interferers much like the approach using a single phase-locked loop 24.

There is a drawback to this approach that the present approach does not share. In a digital implementation, a single/wide phase-locked loop approach would have to run at a high enough clock speed to resolve the highest frequencies in the band. Actually, it would probably have to run at a much higher rate to avoid ‘chopping’ effects in the phase-locked loop 24. The present flexible approach can run at a clock rate that is on the order of the frequency hopped (FH) modulation bandwidth. Thus, the present flexible scheme can run at an overall lower clock speed.

There is an implementation drawback to the present approach when compared to the single wide-band phase-locked loop approach. The present approach incurs complexity in the bandpass filters 21 and down-converters 22 that the other approach does not suffer. However, an implementation that is able to run these operations in parallel still allows a lower clock rate.

The above alternative approach could be generalized by subdividing the large frequency hopped (FH) bandwidth into sub-bands, which are still wider than the frequency hopped (FH) hopping channel spacing, and applying narrower bandwidth phase-locked loops 24 to each. The trade-offs should be obvious from previous discussions. These approaches are not as flexible as the present approach (see the second example discussed above). In addition, they still will require higher clock rates than the present approach. If the bandwidths are narrowed further, eventually, one will arrive at the present flexible approach.

Another similar approach would be to have a single narrow-bandwidth phase-locked loop 24. The center frequency of an oscillator in the loop is swept across the frequency hopped spread spectrum frequency bandwidth. A lock detection scheme determines whether the loop has locked onto an interferer. Drawbacks of this approach are that to maintain a narrow bandwidth phase-locked loop 24, the frequency sweep must be fairly slow. In a frequency hopped spread spectrum environment, it may take a long time to arrive at the frequency of the interferer. In this time, it is possible that the interferer has hopped to another channel. It may be difficult to track a frequency hopped (FH) interferer with such a system.

Thus, we have described a new flexible approach to FHSS interference suppression. We have presented simulation results which demonstrate the capabilities and trade-offs associated with our approach. In addition, two examples were discussed which highlight the benefits of our suppression scheme. We discussed alternate approaches and discussed their merits and drawbacks.

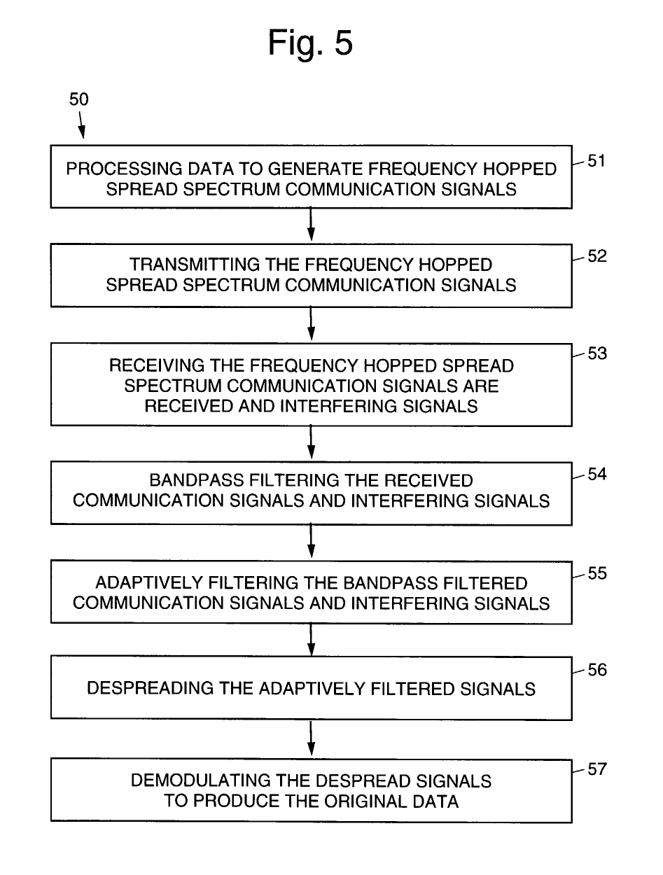

Referring now to FIG. 5, it illustrates an exemplary method 50 in accordance with the principles of the present invention for rejecting interference in a direct-sequence spread spectrum communications system. The method 50 comprises the following steps.

Data is processed to generate 51 direct-sequence spread spectrum communication signals. The direct-sequence spread spectrum communication signals are transmitted 52. The direct-sequence spread spectrum communication signals are received 53 along with interfering signals. The received communication signals and interfering signals are bandpass filtered 54.

The bandpass filtered communication signals and interfering signals are adaptively filtered 55. The adaptive filtering 55 is achieved using a suppression filter 21 and an adaptive algorithm 29 that processes the output of the suppression filter 21 to hop the suppression filter 21 along with the interfering signals. The adaptively filtered signals are despread 56. The despread signals are demodulated 57 to produce the original data with interference that is suppressed.

The present invention adaptively mitigates frequency hopped spread spectrum interference occurring in a direct-sequence spread spectrum communications system. One application of this system provides for the coexistence of a frequency hopped spread spectrum communications systems and a direct-sequence spread spectrum communications system in the same frequency band. Accordingly, the present invention provides for a signal processing scheme that mitigates the interference on a direct-sequence spread spectrum communications system due to a frequency hopped spread spectrum communications system using the same frequency band.

Thus, improved systems and methods for providing a flexible approach to frequency hopped spread spectrum interference suppression have been disclosed. It is to be understood that the above-described embodiments are merely illustrative of some of the many specific embodiments that represent applications of the principles of the present invention. Clearly, numerous and other arrangements can be readily devised by those skilled in the art without departing from the scope of the invention.

What is claimed is:

1. Apparatus for rejecting interference in a direct-sequence spread spectrum communications system, comprising:
(1) an antenna for receiving frequency hopped spread spectrum communication signals and interfering signals;
(2) an amplifier for amplifying the signals received at the antenna;
(3) a plurality of phase-locked loop subunits for processing signals amplified by the amplifier that each comprise:
a plurality of bandpass filters;
a plurality of down-converters respectively coupled to outputs of the plurality of bandpass filters;
a summing device coupled to outputs of the plurality of plurality of down-converters;
a phase-locked loop coupled to an output of the summing device;
a plurality of up-converters coupled an output of the phase-locked loop;
a plurality of complex weighting circuits respectively coupled to the plurality of up-converters;
a plurality of switches respectively coupled to the plurality of complex weighting circuits;
a plurality of output summing devices respectively coupled to the plurality of switches; and
a plurality of weight control circuits respectively coupled between the output summing devices and the complex weighting circuits for setting the weights of the complex weighting circuit; and
(4) a summing device coupled to outputs of each of the plurality of phase-locked loop subunits which provides a summed signal.

2. A method for rejecting interference in a direct-sequence spread spectrum communications system, comprising the steps of:
processing data to generate direct-sequence spread spectrum communication signals;
transmitting the direct-sequence spread spectrum communication signals;
receiving the direct-sequence spread spectrum communication signals and interfering signals;
bandpass filtering the received communication signals and interfering signals;
adaptively filtering the bandpass filtered communication signals and interfering signals using a suppression filter and an adaptive algorithm that processes the output of the suppression filter and an estimate of the hopping frequency of the interfering signals to hop the suppression filter along with the interfering signals;
despreading the adaptively filtered signals; and
demodulating the despread signals to produce the original data.
